(19) United States
(12) Patent Application Publication
(10) Pub. No.: US 2004/0027090 A1
(43) Pub. Date: Feb. 12, 2004

(54) Magnetic / electric drive unit system

(76) Inventor: Henry Freeman Winterheld, Austin, TX (US)

Correspondence Address: Henry F. Winterheld, P.O. Box 80235, Austin, TX, 78708, US

(21) Appl. No.: 10/212,354

(22) Filed: Aug. 6, 2002

(51) Int. Cl. H02P 5/34

(52) U.S. Cl. 318/800

(57) ABSTRACT

What I am proposing is a propulsion unit for an automobile that doesn't use fossil fuels and consequently releases no harmful emissions into the air that we breathe. The energy for the drive unit comes to us naturally in the form of magnets. The opposing forces of these magnets is where the energy comes from. The rest of the system is already being used as propulsion means for boats but has never been used for automobiles. Magnetic energy works and will work in this system.

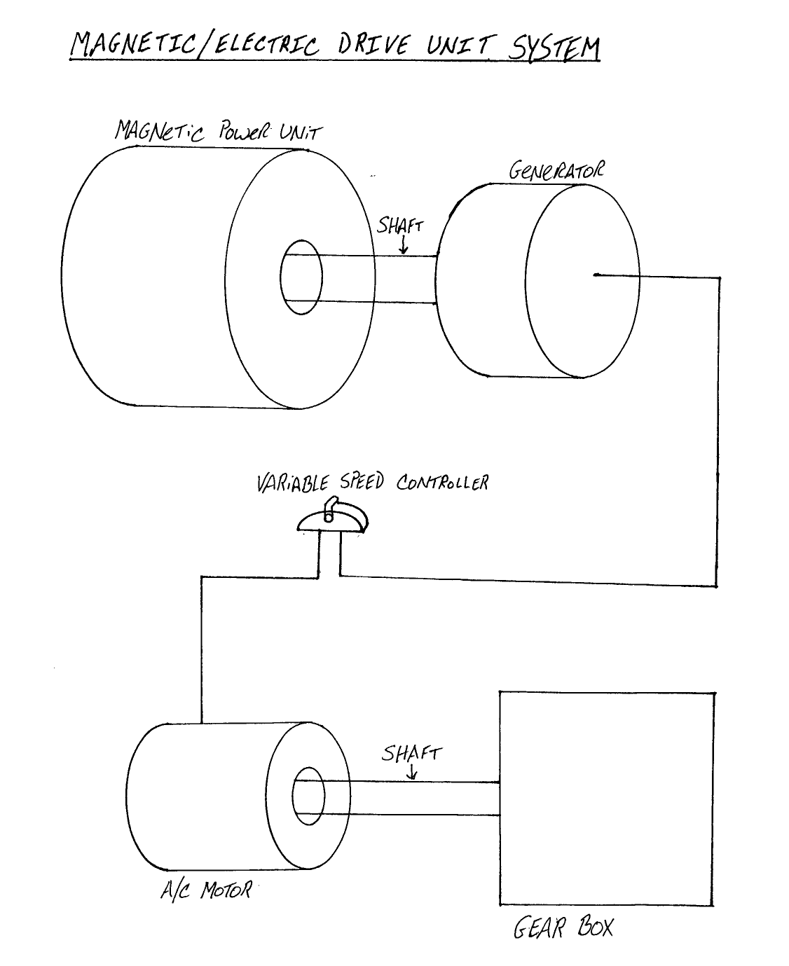

### BACKGROUND OF INVENTION

The area to which this invention pertains is the automotive area or any area where propulsion is needed. The problem to which this particular system targets is fossil fuel and air emissions. This type of system exists currently as diesel electric used on locomotives and off shore vessels However, the power unit for the generation of electricity in my system has not been used This is the change I am making.

### BRIEF SUMMARY OF INVENTION

The general concept and use of the system has been used for many years but never in the automotive industry and in the way I have described. The problem with today's automobiles (and ones of the past) is two fold.

First: The dependence on fossil fuels is growing more and more each year and it won't be long before fossil fuels are a thing of the past because of the ever increasing use of them. The system I have come up with doesn't use fossil fuels or any fuel for that matter. This is free energy.

Second: With fossil fuels we get air emissions which are continually ruining the air that we breathe, yet we justify it by saying that we need our automobiles. With the system I have come up with no emissions are present because no fuels are burned in the process. Again, this is free energy.

### BRIEF DESCRIPTION OF DRAWING

The drawing is a generalized schematic of the magnetic/electric drive unit system. The magnetic power unit and the generator are connected by a common shaft. The produced electricity from the generator is sent to a rheostat or variable speed controller which controls the amount of electricity going to the a/c motor The a/c motor is connected to a gear box (not unlike a transmission) which will turn the wheels of the car and produce propulsion.

### BACKGROUND OF INVENTION

The area to which this invention pertains is the automotive area or any area where propulsion is needed. The problem to which this particular system targets is fossil fuel and air emissions. This type of system exists currently as diesel electric used on locomotives and off shore vessels. However, the power unit for the generation of electricity in my system has not been used. This is the change I am making.

### BRIEF SUMMARY OF INVENTION

The general concept and use of the system has been used for many years but never in the automotive industry and in the way I have described. The problem with today's automobiles (and ones of the past) is two fold.

First: The dependence on fossil fuels is growing more and more each year and it won't be long before fossil fuels are a thing of the past because of the ever increasing use of them. The system I have come up with doesn't use fossil fuels or any fuel for that matter. This is free energy.

Second: With fossil fuels we get air emissions which are continually ruining the air that we breathe, yet we justify it by saying that we need our automobiles. With the system I have come up with no emissions are present because no fuels are burned in the process. Again, this is free energy.

### BRIEF DESCRIPTION OF DRAWING

The drawing is a generalized schematic of the magnetic/electric drive unit system. The magnetic power unit and the generator are connected by a common shaft. The produced electricity from the generator is sent to a rheostat or variable speed controller which controls the amount of electricity going to the a/c motor. The a/c motor is connected to a gear box (not unlike a transmission) which will turn the wheels of the car and produce propulsion.

### DETAILED DESCRIPTION OF INVENTION

The only thing new in this invention is putting the magnetic power unit in with a propulsion system. The magnetic power unit has an outside ring of stationary magnets and an inside ring of magnets on a rotating wheel. The opposing force of the magnets creates the spinning of the wheel which has a shaft connected to it which is also connected to a generator. As the shaft turns the internals of the generator it generates electricity. This constant electrical output is sent to a variable speed controller (rheostat) which controls the output to the a/c motor. The a/c motor, reacting to the amount of electricity it is receiving, increases or decreases it's shaft rpm accordingly. The a/c motor shaft is connected to a gearbox (like a transmission) which rotates the wheels of the car accordingly (faster or slower). This gearbox can be set to rotate the wheels so the vehicle moves forward or backwards.

1. What I claim as my invention is the Magnet/Electric drive unit system. This system in it's entirety has not, to my knowledge, been used before for what I am proposing to use it for.
